(19) United States
(12) Patent Application Publication
(10) Pub. No.: US 2013/0220080 A1
(43) Pub. Date: Aug. 29, 2013

(54) NAIL POSITIONING DEVICE

(71) Applicant: Yeo-Ming WANG, Taipei (TW)

(72) Inventor: Yeo-Ming WANG, Taipei (TW)

(21) Appl. No.: 13/406,189

(22) Filed: Feb. 27, 2012

(51) Int. Cl. B25C 3/00

(52) U.S. Cl. 81/44

(57) ABSTRACT

A nail positioning device comprising a main body with specific elasticity and thickness; an insert penetration hole formed on the main body and penetrating vertically from top to bottom of the main body, and parallelly interconnected to an exit through slot, and the exit through slot being interconnected to the periphery of the main body, such that the exit through slot and the insert penetration hole form an open slot; and a low adhesive glue coated on a bottom surface of the main body or the main body being made of a low adhesive material, so that a nail can be positioned appropriately without requiring users to hold the nail by hand before the nail is hammered, so as to provide excellent positioning effect and operation safety, while using the low adhesive glue to be attached onto a construction surface for repeated uses.

### BACKGROUND OF THE INVENTION

1. Field of the Invention

The present invention relates to a positioning device, and more particularly to the nail positioning device used for positioning a nail and hammering the nail to provide a convenient, simple, easy and safe nailing operation.

2. Description of Related Art

In general, a nail is used for hanging household items such as a clock and paintings securely, or used in a nailing operation for decorative constructions or fixing objects. A hammer is usually used for hammering the nail, and it is necessary to position the nail first and then hammer at the nail, and the operation is inconvenient and sometimes dangerous. Therefore, a conventional nail positioning device as shown in FIG. 1 was introduced, wherein the nail positioning device 90 is substantially in the shape of a plate having a plurality of X-shaped slots 91, and a positioning point 92 formed at the middle position of the X-shaped slots 91. During operation, a user holds the nail positioning device 90 close to a wall 102 by a hand 101, and then passes a nail 93 through the positioning point 92 of the nail positioning device 90, and the middle position of the X-shaped slots 91 clamps the nail 93, such that the nail 93 can be positioned temporarily, and then a hammer 103 strikes at the nail 93. After a part of the nail 93 is hammered into the wall 102, the nail positioning device 90 can be withdrawn backwardly along the nail 93, and finally the nail 93 is banged to a required nailing condition. Although the foregoing conventional nail positioning device 90 can position the nail 93 without requiring a user to hold the nail 93 by a hand before hammering the nail 93 to avoid the danger, the conventional nail positioning device 90 still has the following drawbacks. For example, after the nail positioning device 90 is withdrawn backward along the nail 93 after the nail 93 is hammered into the wall 102, the operation is relatively more troublesome, and the X-shaped slots 91 or even the nail positioning device 90 may be damaged easily. Obviously, the conventional nail positioning device 90 requires improvements. In addition, before the nail 93 is hammered into the wall 102, the nail positioning device 90 may not be aligned precisely with a nailing position of the nail 93 if the user's hand slides or shakes, or the hammer 103 strikes at the nail 93 to move the nail positioning device 90. This is another drawback of the conventional positioning device 90 that requires further improvements. Therefore, it is an important subject for related manufacturers to overcome the drawbacks of the conventional nail positioning device.

In view of the aforementioned problems, the inventor of the present invention conducted extensive researches and experiments, and finally developed a practical, convenient and safe nail positioning device in accordance with the present invention.

### SUMMARY OF THE INVENTION

Therefore, it is a primary objective of the present invention to provide a nail positioning device that can position a nail appropriately without requiring users to hold the nail by hand before the nail is hammered and fixed, so as to provide excellent positioning effect and operation safety.

Another objective of the present invention is to provide a nail positioning device that can be withdrawn and removed conveniently without damaging the nail before the nail is hammered and fixed, so as to assure the service life of the nail positioning device.

A further objective of the present invention is to provide a nail positioning device that can be adhered onto a wall or at a nailing position to actively avoid the nail from being crooked and skewed from the nail position.

Another objective of the present invention is to provide an appropriate alignment standard to facilitate calibrating and determining the nailing position of the nail.

To achieve the aforementioned objectives, the present invention provides a nail positioning device comprising: a main body with specific elasticity and thickness, an insert penetration hole formed on the main body and penetrating vertically from top to bottom of the main body, and parallelly interconnected to an exit through slot, and the exit through slot being interconnected to the periphery of the main body, such that the exit through slot and the insert penetration hole form an open slot, and the main body with a low adhesive glue attached to a bottom surface of the main body, and the low adhesive glue can be formed by coating, and the low adhesive glue can be attached onto a construction surface and reused after the low adhesive glue is peeled off.

To achieve aforementioned objective, the present invention further provides another nail positioning device, wherein the main body is made of a low adhesive material, and the low adhesive glue can be attached onto a construction surface and reused after the low adhesive glue is peeled off.

The technical characteristics and effects of the present invention will become apparent with the detailed description of preferred embodiments accompanied with related drawings as follows.

### BRIEF DESCRIPTION OF THE DRAWINGS

FIG. 1 is a schematic view of a conventional nail positioning device;

FIG. 2 is a perspective view of a first preferred embodiment of the present invention;

FIG. 3 is a schematic view of an operation of the first preferred embodiment of the present invention;

FIG. 4 is an exploded view of a second preferred embodiment of the present invention;

FIG. 5 is a top view of second and third preferred embodiments of the present invention;

FIG. 6 is a perspective view of a fourth preferred embodiment of the present invention; and

FIG. 6a is a side view of the fourth preferred embodiment of the present invention.

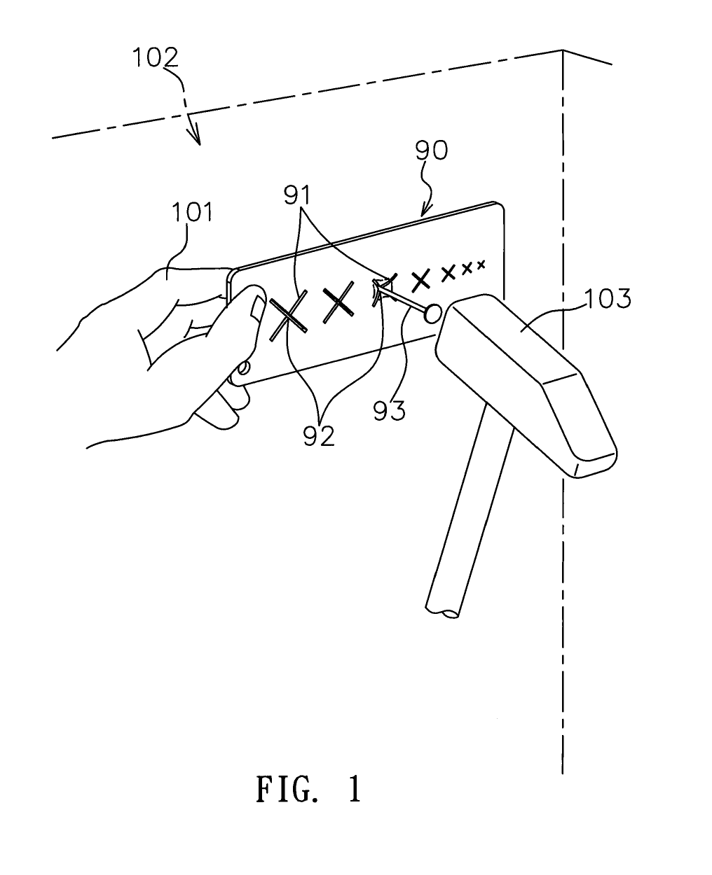

### DETAILED DESCRIPTION OF THE PREFERRED EMBODIMENTS

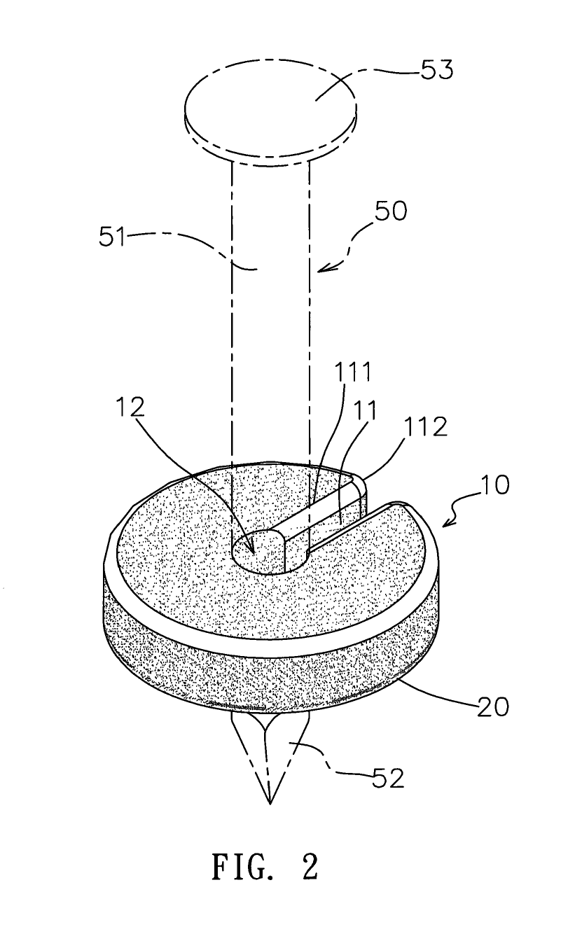

With reference to FIG. 2 for a nail positioning device in accordance with the first preferred embodiment of the present invention, the nail positioning device comprises a main body 10 with specific elasticity and thickness (or made of a material including foam, pearl cotton, rubber or plastic), and an insert penetration hole 12 and an exit through slot 11 formed on the main body 10, wherein the insert penetration hole 12 is formed on the main body 10. In an appropriate embodiment, the insert penetration hole 12 can be formed at the middle position of the main body 10. The exit through slot 11 is penetrated through the main body 10, and an end of the exit through slot 11 is coupled to the insert penetration hole 12, and the other end of the exit through slot 11 is disposed at the periphery of the main body 10. In other words, the exit through slot 11 is parallelly interconnected from the periphery of the main body 10 to the insert penetration hole 12, such that the insert penetration hole 12 and the exit through slot 11 form an open slot. In addition, the exit through slot 11 has an arc-edge surface 111 and an arc-end surface 112 disposed on both sides of the top and the peripheral surface of the main body 10 separately.

Further, a nail 50 is inserted into the insert penetration hole 1. In other words, a front nail tip 52 of the nail 50 is passed into the insert penetration hole 12 of the main body 10 and clamped, such that the main body 10 is fixed before the nail 50 is hammered and fixed, and then the bottom surface 20 of the main body 10 is attached onto the construction surface. Now, the striking position is situated at a rear nail head 53 of a nail shank 51 at the rear of the nail 50. In the aforementioned operation method, the bottom surface 20 of the main body 10 can be attached onto the construction surface first, and then a nail 50 is inserted into the insert penetration hole 12, and the operation method is not limited to this arrangement only. In practical applications, the insert penetration hole 12 of the main body 10 can have a choice of different hole diameters, and the hole diameter of the insert penetration hole 12 is slightly smaller than the external diameter of the nail 50 (or the nail shank 51) to facilitate clamping and fixing the nail 50 by the insert penetration hole 12. Since the main body 10 has an elasticity, the insert penetration hole 12 (of the main body 10) can be expanded slightly (as described in details below).

In addition, a low adhesive glue on the bottom surface 20 of the main body 10 can be attached onto a construction surface (such as a wall), and after the bottom surface 20 is separated from the construction surface, the bottom surface 20 can be reused. The low adhesive glue can be formed on the bottom surface 20 of the main body 10 by coating.

In addition, the main body 20 can be made of a low adhesive material (such as gel or low adhesive resin glue), and the low adhesive glue can be attached onto the construction surface or reused after being peel off.

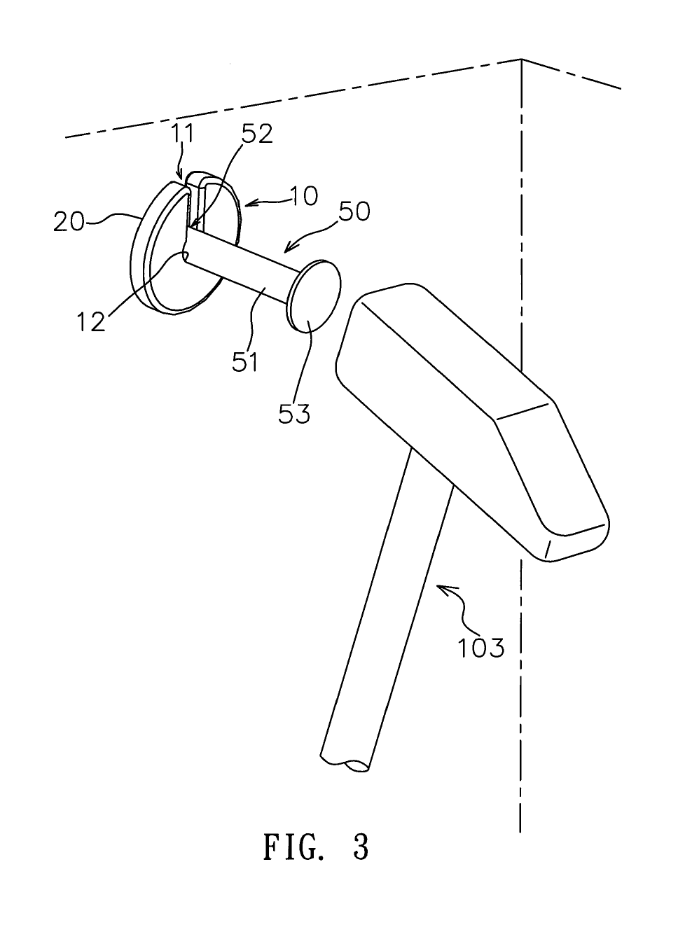

With reference to FIG. 3, a hammer 103 (or any other hammering tool) is used to strike at the rear nail head 53 of the nail 50. After the nail 50 is temporarily fixed onto the construction surface, the main body 10 can be separated from the nail 50 through the exit through slot 11. Now, the nail 50 can be hammered and fixed according to the requirement of the construction, or an appropriate length of the nail shank 51 is hammered into the construction surface, or the rear nail head 53 abuts the construction surface. Therefore, the present invention does not require users to hold the nail 50 or the main body 10 by hand to hammer the nail 50 by the hammer 103, so as to meet the safety requirement of a high standard.

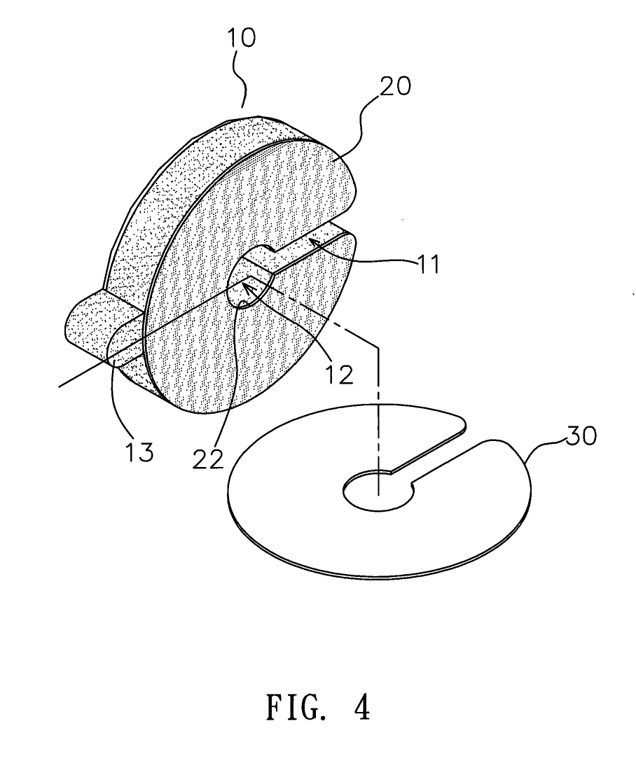

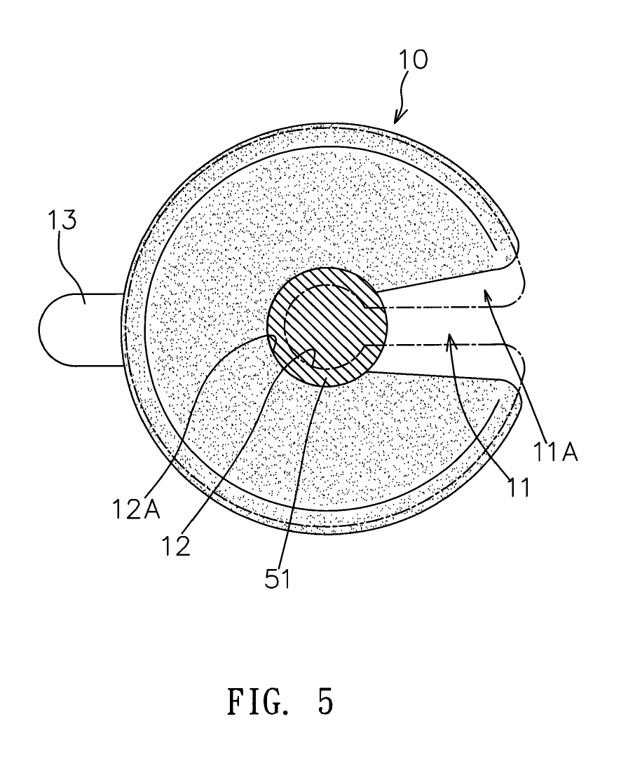

With reference to FIGS. 4 and 5 for a nail positioning device in accordance with the second and third preferred embodiments of the present invention respectively, these preferred embodiments are based on the structure of the first preferred embodiment with the following differences. In the second preferred embodiment, a handle plate 13 is protruded from the periphery of the main body 10, and the handle plate 13 can be integrally formed with the main body 10, and the handle plate 13 is provided for users to grip easily by hands.

In the third preferred embodiment, a release layer 30 is further disposed at the bottom surface 20 of the main body 10 and attached and fixed onto the bottom surface 20 to prevent the low adhesive glue of the bottom surface 20 from being contaminated or losing the adhesiveness before the low adhesive glue is used. During use, the release layer 30 is peeled off from the bottom surface 20, and then the main body 10 is attached onto the construction surface.

In FIG. 5, when the nail shank 51 is passed through the insert penetration hole 12, the insert penetration hole 12 of the main body 10 is expanded to an insert penetration hole 12A with a larger hole diameter, while the exit through slot 11 is also expanded to an exit through slot 11A with a larger openness.

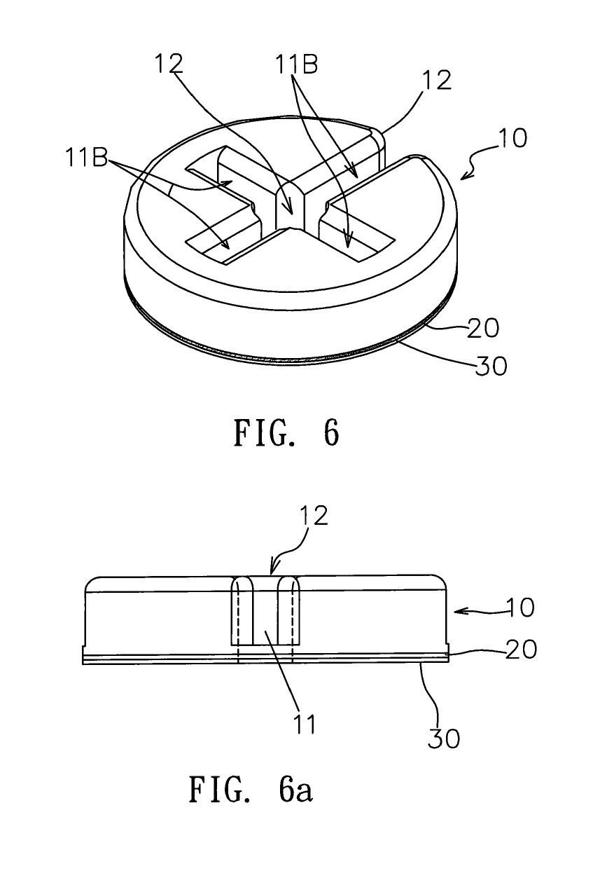

With reference to FIGS. 6 and 6a for the nail positioning device in accordance with the fourth preferred embodiment, this preferred embodiment is based on the structure of the aforementioned preferred embodiments (including the first, second and third preferred embodiments) with the following difference. A cross notch 11B is formed at the top of the main body 10, and the cross notch 11B comprises the exit through slot 11 used for withdrawing the nail, and the whole cross notch 11B (including the exit through slot 11) is used as an alignment standard of the main body 10 to facilitate calibrating and determining a nailing position of the nail.

Therefore, the nail positioning device of the present invention with the aforementioned assembly can fix the nail at an appropriate position before the nail is hammered and fixed. When the nail is hammered, users need not to hold the nail by hands, so as to facilitate the positioning and provide a safe operation. In the meantime, the nail positioning device can be withdrawn or removed before the nail is finally hammered to avoid damaging the nail positioning device and assure the service life of the nail positioning device. In addition, the present invention can attach the nail positioning device onto a wall or at a nailing position conveniently to prevent the nail from crooked or skewed from the nail position. The nail positioning device of the present invention provides an appropriate alignment standard to facilitate calibrating and determining the nailing position of the nail, and also provides a convenient way to peel off the adhesive layer to provide the reusable function.

In summation of the description above, the present invention overcomes the shortcomings of the prior art and complies with patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A nail positioning device, comprising a main body with specific elasticity and thickness, an insert penetration hole formed on the main body and penetrating vertically from top to bottom of the main body, and parallelly interconnected to an exit through slot, and the exit through slot being interconnected to the periphery of the main body, such that the exit through slot and the insert penetration hole form an open slot, and the main body with a low adhesive glue to facilitate attaching onto a construction surface.

2. The nail positioning device of claim 1, wherein the low adhesive glue is formed on a bottom surface of the main body by coating.

3. The nail positioning device of claim 1, wherein the main body is made of a low adhesive material.

4. The nail positioning device of claim 1, wherein the exit through slot has an arc-edge surface disposed on both sides of the top of the main body.

5. The nail positioning device of claim 1, wherein the exit through slot has an arc-end surface disposed on the peripheral surface of the main body.

6. The nail positioning device of claim 2, wherein the low adhesive glue on the bottom surface is reusable.

7. The nail positioning device of claim 1, wherein insert penetration hole has a hole diameter smaller than an external diameter of an inserted nail and a nail shank of the insert nail.

8. The nail positioning device of claim 1, wherein the bottom surface of the main body further comprises a release layer for preventing the low adhesive glue from being contaminated and losing its adhesiveness before use.

9. The nail positioning device of claim 1, wherein the main body comprises a handle plate protruded from the periphery of the main body.

10. The nail positioning device of claim 1, wherein the main body has cross notch including the exit through slot formed on the top surface of the main body.
